(19) United States
(12) Patent Application Publication
(10) Pub. No.: US 2010/0056120 A1
(43) Pub. Date: Mar. 4, 2010

(54) METHOD AND SERVER FOR FILTERING TELEPHONE CALLS

(76) Inventors: Christian Olrog, Stockholm (SE); Lennart Hellström, Skondal (SE); Stefan Sjoovist, Stockholm (SE); Arash Beygzadeh, Solna (SE); Urban Theander, Tyreso (SE); Torbjörn Dahlen, Knivsta (SE); Tomas Ravin, Stockholm (SE); Klas Lundin, Varmdo (SE)

Correspondence Address: ERICSSON INC., 6300 LEGACY DRIVE, M/S EVR 1-C-11, PLANO, TX, 75024, US

(21) Appl. No.: 12/516,050

(22) PCT Filed: Nov. 30, 2006
(86) PCT No.: PCT/EP2006/069149

§ 371 Date: May 22, 2009

(51) Int. Cl. H04M 3/42

(52) U.S. Cl. 455/415

(57) ABSTRACT

The present relates to a method and server for collecting call information associated with an incoming call to a user terminal attached to said telecommunication network. The server comprises determining means for determining a set of answering options to be provided to the user terminal based at least on said call information, and transmitting means for transmitting information indicating the determined set of answering options to the user terminal.

### TECHNICAL FIELD

The present invention relates to a method and a server in a telecommunication network. In particular, the invention relates to a method and server providing configurable answering options.

### BACKGROUND

Existing telecommunication user terminals provide the user with a few fixed limited number of answering options when an incoming call is received. The user may e.g. be given the answering options answer, busy or mute. These answering options are supported in the user terminal, although the network can give additional support, by providing time-out functions, and redirect to e.g. voicemail.

U.S. Pat. No. 6,574,471 B1 relates to method and user terminal for handling incoming calls received by a mobile phone during a meeting. The mobile phone comprises a screen display having several default setting options for handling incoming calls. These options include diverting calls to an assistant, diverting calls to voice mail and e.g. placing the caller on hold. However, the user has to choose a default setting that is the same independently of the caller of the incoming call.

Thus, the existing answering options must be configured in advanced and can therefore not adapt to the characteristics of a specific incoming call. Hence, incoming calls may not be handled in an efficient way by the existing answering options.

### SUMMARY

The object with the present invention is to provide a method and an arrangement that makes it possible for a user to improve management of incoming calls to the user.

The object is according to a first aspect achieved by a server in a telecommunication network adapted to collect call information associated with an incoming call to a user terminal attached to said telecommunication network. The server comprises determining means for determining a set of answering options to be provided to the user terminal based at least on said call information, and transmitting means for transmitting information indicating the determined set of answering options to the user terminal.

According to a second aspect, the present invention relates to a method in a telecommunication network for collecting call information associated with an incoming call to a user terminal attached to said telecommunication network. The method comprises the steps of determining a set of answering options to be provided to the user terminal based at least on said call information, and transmitting information indicating the determined set of answering options to the user terminal.

In accordance with embodiments of the invention the call information comprises at least one of an identity of the caller of the incoming call, subject of the incoming call.

The server comprises preferably further means for collecting user information of the user of the user terminal and means for determining a set of answering options to be provided to the user terminal based at least on said call information and said user information. The user information comprises e.g. at least one of terminal capability information, enterprise policy, project participation.

According to a preferred embodiment, the server is implemented in a SIP proxy. Further, the transmitting means for transmitting information indicating the determined set of answering options to the user terminal may be adapted to use a SIP invite message, to use an extra body of SIP invite message, or to use a reference URI.

Moreover, the server may be associated to a monitoring server adapted to collect the call information by monitoring a call.

An advantage with the present invention is that it provides an improved and more flexible control over how to handle incoming communication requests.

A further advantage is that the present invention allows the called user to make an answering decision in real-time for the handling of incoming calls. The decision may be based on calling party information (including project or information about previous communication), suitable alternate destinations; coworkers (and the coworkers current (status/availability), voicemail including option to forward to these destinations “with a click”, suitable alternate means of communication; Video, Text, etc.

This results in more professional call handling, with fewer ones being bluntly rejected. This replaces the need for the user to set accessibility daily such as “I'm in a meeting from now to 12.00”, “I am now out of office etc.”, which few users actually use. Instead the user preferences are only needed to be set seldom based on enterprise policy, users' general presence/preferences and/or group/project participation.

### BRIEF DESCRIPTION OF THE DRAWINGS

FIG. 1 illustrates a server according to the present invention.

FIG. 2 illustrates a scenario when SIP is used to implement an embodiment of the invention.

FIG. 3 illustrates an embodiment of the present invention.

FIG. 4 is a flowchart of the method according to the present invention.

### DETAILED DESCRIPTION

The basic idea with the present invention is to provide answering options to a user of an incoming call that are adapted to said incoming call and preferably also to the user and the terminal of said user. That implies that the answering options may depend on the caller, the subject of the incoming call, user preferences, terminal capabilities etc.

When there is an incoming call to the user, the server according to the present invention is arranged to provide the user with answering options and also preferably information regarding the incoming call such as caller, subject, and answering options. As stated above, the answering options depend according to the present invention on characteristics of the incoming call, referred to as call information and according to a preferred embodiment also on user preferences and terminal capabilities.

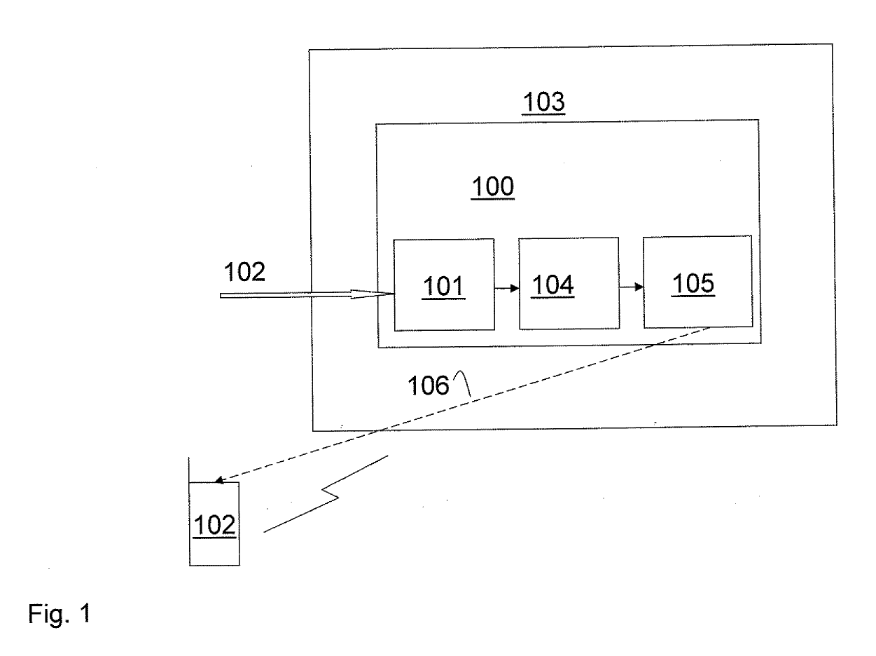

Hence, the present invention relates to a server 100 in a telecommunication network 103 illustrated in FIG. 1. The server 100 is adapted to collect 101 call information 102 associated with an incoming call to a user terminal 102 attached to said telecommunication network 103. The call information is preferably collected from backend information systems. The search engine Google may be used to do a lookup on the incoming name or number and present the feeling lucky page along with options encoded in that page. For enterprises, it is preferred to use a CRM (customer relationship management) system which holds information about all ongoing projects and customers. The server 100 comprises determining means 104 for determining a set of answering options to be provided to the user terminal 102 based at least on said call information, and transmitting means 105 for transmitting information indicating the determined set of answering options to the user terminal.

The user may store his preferences in the network (e.g. in an XDMS (XML Document Management Server) node if it is an IMS network), which combined with the current capabilities of the phone (made possible by current network/location characteristics) produce an overall composed characteristic. Preferences include by whom the user would like to be contacted and how the user would like to communicate. The network or corporate information system also keeps information on suitable alternative destinations/colleagues. Characteristics relating to the user and the terminal are referred to as user information. The answering options appear preferably on the terminal display such that the user can select at least one of them. Below, is an example shown where it is possible to select more than one answering option. Further, the status (e.g. available, busy etc.) of the users that the user of the incoming call may redirect the incoming call to is indicated.

Examples of the answering options are:

Redirect to:

Department Sales
Joey (Available)
Rachel (In a meeting)

Department Support
Monica (Busy—only critical issues)
Chandler (Available for Instant Message chat)

Another example is when a session is setup between two employees of a single company wherein the options on the receiving end may be to choose voice and text chat. When it is between an employee of a first company and an emplowe of a second company, the policy might be to include video or weshare as an option.

Call information implies identities associated with the caller such as phone number and other parameters associated with the caller such as project participation of the caller. User information implies e.g. terminal capability, project participation and enterprise policy.

Examples of Customer information are Name and current projects. An example of Project participation information are Name of colleague(s) involved with customer e.g. suitable to handover to.

Examples of terminal capabilities are SMS, Video, Chat, weshare. (It should be noted that current network capabilities influence these as well as Quality of Service may not be high enough to provide e.g. Video even though the phone and user support prefer it.)

An example of enterprise policy is that certain customers may allow for video calls when abroad and some not due to money restrictions.

Examples of typical answering options are

Answer

Answer, but use alternative media input. (E.g. for an incoming voice call, use text input on receivers end and transcode to voice in the network.)

Reject

Reject with a message. The message (text or voice) can be a predefined message and configurable

Propose other communication means, e.g. IM instead of voice

Redirect, e.g. to Voicemail, or e.g. a Project colleague

Other enterprise functions e.g. explicitly chosen interactive voice response scripts.

The user may select among the selected answering options by a graphical user interface on the terminal, by means of a keypad or by voice messages depending on the user terminal capabilities.

Thus, the answering options may appear on a user terminal display graphically in such a way that the user can select an option by e.g. pushing a button.

Thus, the response by the receiving user can result in a Session start if the answering option “Answer” is selected, Session reject if the answering option “reject” is selected, Information to the calling user if, followed by session end if the answering option “reject with a message” is selected, or information to the calling user, to renegotiate the session parameters (e.g. an incoming video setup request can be renegotiated to result in a text chat session instead) if a response with e.g. short text message is selected.

The session information contains the answering options which are interpreted locally in the device of the user receiving the incoming call. The answering options may also comprise actions identified as remote commands. Locally interpreted implies that the answering option “Answer” is executed locally, such as display of presence information about colleagues presented in the GUI. Remote commands may be the equivalent to transfer to a colleague where the answering user's device simply asks the server to do it which will be invoked on an external resource (e.g. PBX (private branch exchange), centrex or an IMS application server. The locally interpreted and the remote commands which are transmitted as options in the call setup request can take parameters (e.g. a text string, a photo, a phone number).

The session information including pertinent answering options and additional information such as status (e.g. busy, available) of another user is added by a server that is aware of the user's preferences and aware of any session setup requests. Depending on the type of the network, there are different solutions to make the server aware of the user preferences and the terminal capabilities. E.g. in the IMS (IP multimedia subsystem), the terminal can send capabilities and preferences to a combined XDMS and presence server, which implies that the server of the present invention can retrieve relevant information from said combined server. It is also possible for the server to send a probe to probe capabilities, e.g. by means of a SIP (Session Initiation Protocol) OPTIONS request During the course of the session setup or the established session the server can send out updates answering options—this enables updating of the answering options in real time.

The present invention is preferably implemented by using SIP as a two way communications bearer with possibility to synchronize session setup requests and session information. Session setup requests are SIP INVITE and session information may either be transferred by means of SIP INFO or in the SIP INVITE as a part of the SIP message body.

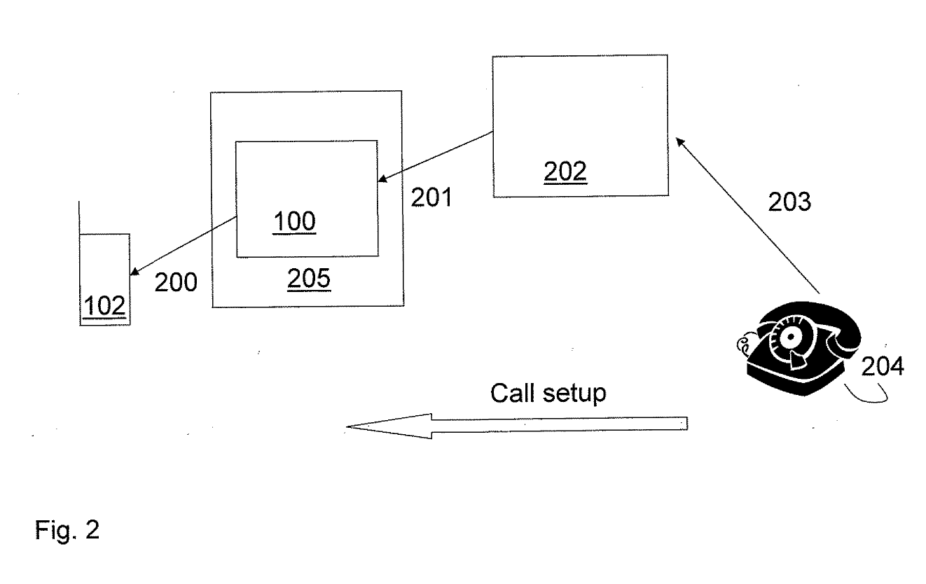

An implementation according to an embodiment is illustrated schematically in FIG. 2. A first user 204 calls a second user 102 and a call set up is initiated. The call is a SIP call and a SIP invite 203 is transmitted to an originating SIP proxy 202. The originating SIP proxy forwards the SIP invite 201 to a terminating SIP proxy 205. The terminating SIP proxy 205 comprises the server 100 according to the present invention. The server is, as stated above, adapted to collect call information associated with an incoming call to the second user. The server comprises determining means for determining a set of answering options to be provided to the user terminal of the second user, based at least on said call information, and transmitting means for transmitting information indicating the determined set of answering options to the user terminal of the second user.

Thus, according to an embodiment the session information is sent from the server to the user that receives the incoming call over as an extra body of the invite message (e.g. packaged as an html page) or just as a reference URI (e.g. an http URL) where information about the session can be retrieved.

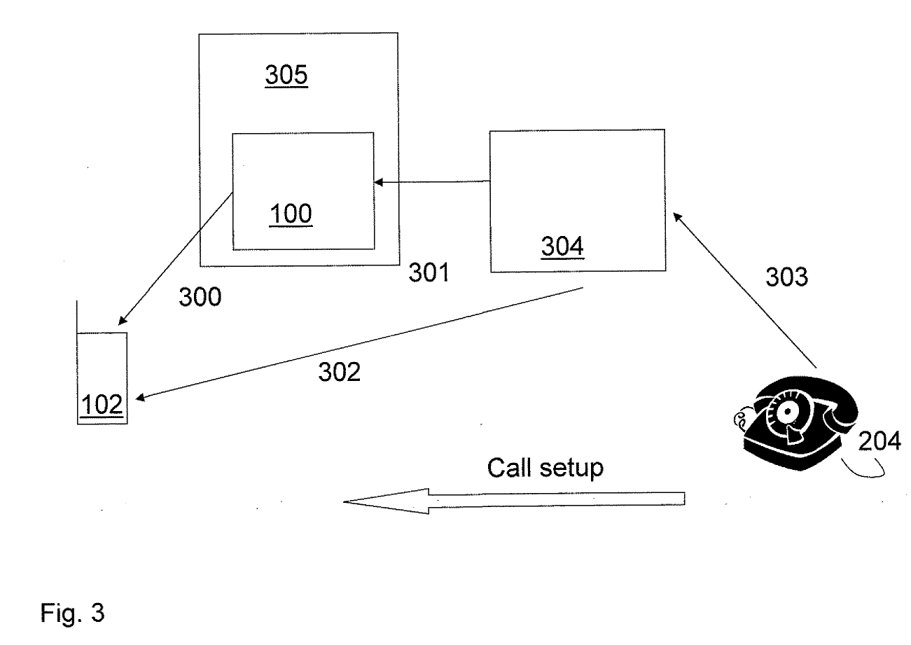

FIG. 3 illustrates the scenario when a first user 204 is calling a second user 102 and an ordinary PSTN session 303, 302 is used. That implies that the users establish a connection to a MSC 304. The session is monitored by a monitoring server 305. The monitoring server comprises the server 100 according to the present invention which is adapted to collect the call information associated with an incoming call to the second user from the MSC by the monitoring server 305, e.g. by means of a monitoring protocol such as Parlay or CSTA (Computer Supported Telephony Applications). The server comprises determining means for determining a set of answering options to be provided to the user terminal of the second user, based at least on said call information, and transmitting means for transmitting information indicating the determined set of answering options to the user terminal of the second user.

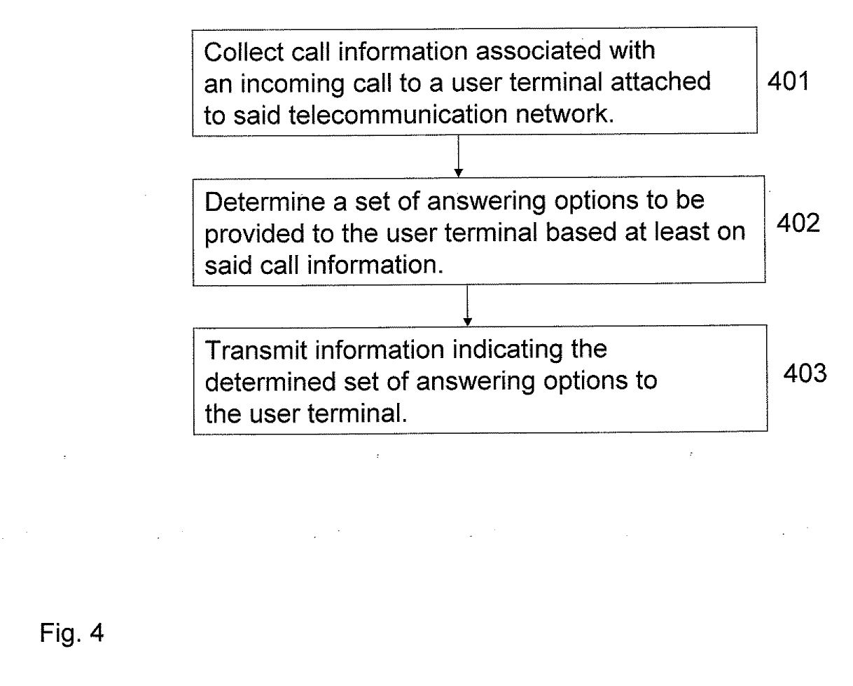

The invention also relates to a method. The method is shown in the flowchart of FIG. 4 and comprises the steps of:

401. Collect call information associated with an incoming call to a user terminal attached to said telecommunication network.

402. Determine a set of answering options to be provided to the user terminal based at least on said call information.

403. Transmit information indicating the determined set of answering options to the user terminal.

According to an embodiment, the method comprises the further steps of collecting user information of the user of the user terminal and then determining the set of answering options to be provided to the user terminal based at least on said call information and said user information.

Further, the call information may be collected by monitoring the call as explained above in conjunction with FIG. 3.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A server in a telecommunication network for collecting call information associated with an incoming call to a user terminal attached to said telecommunication network, comprising:
determining means for determining a set of answering options to be provided to the user terminal based at least on said call information; and
transmitting means for transmitting information indicating the determined set of answering options to the user terminal.

2. The server according to claim 1, wherein the call information comprises at least one of an identity of the caller of the incoming call; subject of the incoming call.

3. The server according to claim 1, wherein the server comprises:
means for collecting user information of the user of the user terminal; and
means for determining a set of answering options to be provided to the user terminal based at least on said call information and said user information.

4. The server according to claim 3, wherein the user information comprise at least one of terminal capability information, enterprise policy, project participation.

5. The server according to claim 1, wherein the server is implemented in a SIP proxy.

6. The server according to claim 5, wherein the transmitting means for transmitting information indicating the determined set of answering options to the user terminal uses a SIP invite message.

7. The server according to claim 5, wherein the transmitting means for transmitting information indicating the determined set of answering options to the user terminal uses an extra body of SIP invite message.

8. The server according to claim 5, wherein the transmitting means for transmitting information indicating the determined set of answering options to the user terminal uses a reference URI.

9. The server according to claim 1, wherein it is associated to a monitoring server collects the call information by monitoring the call.

10. A method in a telecommunication network for collecting call information associated with an incoming call to a user terminal attached to said telecommunication network, comprising the steps of:
determining a set of answering options to be provided to the user terminal based at least on said call information, and
transmitting information indicating the determined set of answering options to the user terminal.

11. The method according to claim 10, wherein the call information comprises at least one of an identity of the caller of the incoming call, subject of the incoming call.

12. The method according to claim 10, comprising:
collecting user information of the user of the user terminal; and
determining a set of answering options to be provided to the user terminal based at least on said call information and said user information.

13. The method according to claim 12, wherein the user information comprise at least one of terminal capability information, enterprise policy, project participation.

14. The method according to claim 10, wherein the method is implemented in a SIP proxy.

15. The method according to claim 14, wherein the step of transmitting information indicating the determined set of answering options to the user terminal is using a SIP invite message.

16. The method according to claim 14, wherein the step of transmitting information indicating the determined set of answering options to the user terminal is using an extra body of SIP invite message.

17. The method according to claim 14, wherein the step of transmitting information indicating the determined set of answering options to the user terminal is using a reference URI.

18. The method according to claim 10, wherein the call information is collected by monitoring the call.
